(19) United States
(12) Patent Application Publication
(10) Pub. No.: US 2009/0262214 A1
(43) Pub. Date: Oct. 22, 2009

(54) AUTOMATIC LIGHTING CONTROL APPARATUS

(76) Inventor: Wen-Hsiung Hsieh, Keelung (TW)

Correspondence Address: Wen-Hsiung Hsieh, 2F, No. 59, Lane 421, MaiJin Road, Anle District, Keelung, 204, TW

(21) Appl. No.: 12/106,318

(22) Filed: Apr. 20, 2008

(51) Int. Cl. H04N 5/235

(52) U.S. Cl. 348/229.1; 348/E05.034

(57) ABSTRACT

An automatic lighting control apparatus is composed of an optical lens, an image sensor, an image processing unit which is connected to the image sensor, a lighting control unit which is connected to the image processing unit. By use the optical lens and image sensor, the automatic lighting control apparatus can easily capture the images of lighting area of the lighting apparatuses. To process and analysis the images of the lighting area via the image processing unit, the illumination of the images or its related parameters is get and used as the reference for the automatic lighting control apparatus to control the magnitude of light output of the lighting apparatuses to provide sufficient lighting while avoiding unnecessary energy consumption.

### BACKGROUND OF THE INVENTION

a) Field of the Invention

The present invention relates to an automatic lighting control apparatus, and more particularly to an automatic lighting control apparatus which is provided with a function of automatically adjust the magnitude of light output of the lighting apparatuses based on the illumination of the images of lighting area of the lighting apparatuses to be controlled captured by an image sensor.

b) Description of the Prior Art

For lighting apparatuses, which are apparatuses with electric light sources for lighting and can be controlled via turn on and off or adjust the magnitude of their light output, that needed to be controlled automatically, like outdoor streetlamps or building lightings, their control apparatus usually use a timer to turn on and off the lighting apparatuses at the predefined time, or use light sensors, like photocells or phototransistors, to detect the illumination of external environment as a reference to control the lighting apparatuses to provide sufficient illumination levels.

For a lighting control apparatus use a timer, it turns on and off the lighting apparatuses at predefined time set by its user. For this type of lighting control apparatus, it has the disadvantage of unable to respond to the change of environmental luminance caused from the weather's changing, etc.

For a lighting control apparatus with light sensors, it can be arranged to respond to the change of environmental illumination via its light sensors to detect the illumination of external environments. However, it has the disadvantage that a light sensor can only detect the illumination of the small space near the light sensor itself. That would be a problem for lighting apparatuses with a large lighting area, since it's laborious to arrange and set up the light sensors to properly detect the illuminations of the positions in the large lighting area of lighting apparatuses.

The basis for the work was to use an image sensor to capture the images of lighting area of the lighting apparatuses to be controlled. By using an optical lens and image sensor, the automatic lighting control apparatus invented can easily capture the images of lighting area; even the lighting area is large. To process and analysis the images of lighting area via the image processing unit, the illumination of the images or its related parameters is got and used as the reference for the automatic lighting control apparatus to control the magnitude of light output of the lighting apparatuses to maintain proper illumination levels. In addition, the image processing unit has the ability to separately analysis the different zones of the images of the lighting area, therefore, the automatic lighting control apparatus can effectively control the lighting apparatuses based on the illuminations of the different zones of lighting area set by user to accurately provide the light where it's needed.

### SUMMARY OF THE INVENTION

The primary object of the present invention is to provide an automatic lighting control apparatus, which can accurately determine illumination of the lighting area of lighting apparatuses to correctly control the magnitude of light output of the lighting apparatuses, such that the lighting apparatuses can provide the right amount of light where it's needed when the illumination of the lighting area is changed.

Accordingly, the present invention includes primarily an optical lens to project the images of the lighting area of lighting apparatuses to an image sensor, an image sensor to capture the images, an image processing unit to get and process image signals from the image sensor, which can provide parameters such as illuminations of the lighting area. A lighting control unit which is connected to the image processing unit to get control reference values from the image processing unit, such as the illumination of the images or its related parameters such as AGC (Automatic Gain Control) or AEC (Automatic Exposure Control) values; and outputs a lighting control signal to control the lighting apparatuses via adjust their magnitude of light output. Therefore, the lighting apparatuses can provide the right amount of light for proper lighting. By using the lighting control unit to get the illumination of the images captured or its related parameters, the illumination of the lighting area can be accurately determined to correctly control the magnitude of light output of lighting apparatuses, thereby preventing from resulting in the incorrect determination, and providing sufficient lighting while avoiding unnecessary energy consumption.

Accordingly, the present invention can accurately determine the illumination of the lighting area to adjust the magnitude of light output of the lighting apparatuses to maintain proper illumination levels. In addition, the image processing unit has the ability to separately process and analysis different zones of the images of lighting area, therefore, the automatic lighting control apparatus can effectively control the lighting apparatuses based on the illuminations of the different zones of lighting area set by user to provide accurately the light where it's needed.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

### DETAILED DESCRIPTION OF THE PREFERRED EMBODIMENTS

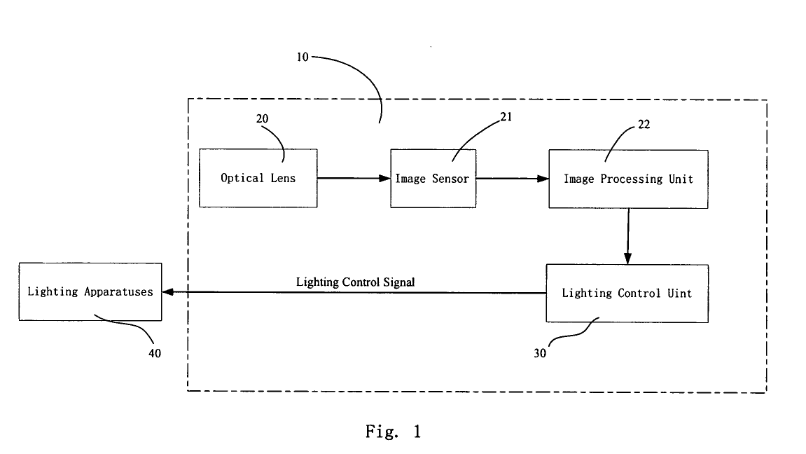

Referring to FIG. 1, it shows a preferred embodiment of the present invention comprises primarily an automatic lighting control apparatus 10, which includes an optical lens 20 to project the images of all or part of lighting area of lighting apparatuses 40 to an image sensor 21, an image processing unit 22 which is connected to the image sensor 21, a lighting control unit 30 which is connected to the image processing unit 22 to control one or more lighting apparatuses 40.

The image sensor 21 can be a CCD (Charge-Coupled Device) or a CMOS (Complementary Metal-Oxide Semiconductor) image sensor, to capture images and to transmit image signals to the image processing unit 22.

The image processing unit 22 is an integrated circuit which operates arithmetic and logic processing or digital signal processing or both, which can be a MCU (Microcontroller Unit), a DSP (Digital Signal Processor), a FPGA (Field-Programmable Gate Array), or a CPLD (Complex Programmable Logic Device). The image processing unit 22 gets and processes the image signals; as well as outputs parameters, such as illumination of the images of lighting area or its related parameters such as AGC (Automatic Gain Control) or AEC (Automatic Exposure Control) values, to the lighting control unit 30.

The lighting control unit 30 is an integrated circuit which operates arithmetic and logic processing or digital signal processing or both, which can be a MCU (Microcontroller Unit), a DSP (Digital Signal Processor), a FPGA (Field-Programmable Gate Array), or a CPLD (Complex Programmable Logic Device). The lighting control unit 30 is connected to the image processing unit 22, to get the illumination of the images of lighting area or its related parameters such as AGC (Automatic Gain Control) or AEC (Automatic Exposure Control) values from the image processing unit 22. The lighting control unit 30 outputs a corresponding lighting control signal in responding to the change of illumination of the lighting area of the lighting apparatuses 40. The lighting control signal is outputted to the lighting apparatuses 40 to adjust the magnitude of light output of the lighting apparatuses 40 to maintain proper illumination levels of the lighting area to provide sufficient lighting while avoiding unnecessary energy consumption. The lighting control signal can be an electric PWM (Pulse Width Modulation) signal, or an electric analog signal or an electric digital signal.

The image sensor 21 and the image processing unit 22 can be configured into a sole integrated circuit. The image processing unit 22 and the lighting control unit 30 can be configured into a sole integrated circuit. The image sensor 21 and the image processing unit 22 and the lighting control unit 30 can be configured into a sole integrated circuit, also.

The lighting apparatuses 40 to be controlled, are apparatuses with electric light sources for lighting and can be controlled via turn on and off or adjust the magnitude of their light output.

As the present invention uses the optical lens 20 and the image sensor 21, the automatic lighting control apparatus 10 can easily capture the images of the lighting area of the lighting apparatuses 40. To process and analysis the images of the lighting area via the image processing unit 22, the illumination of the images or its related parameters is get and used as the reference for the automatic lighting control apparatus 10 to control the magnitude of light output of the lighting apparatuses 40 to maintain proper illumination levels of the lighting area to provide the proper lighting. In addition, the image processing unit 22 has the ability to separately analysis the different zones of images of the lighting area, therefore, the automatic lighting control apparatus 10 can effectively control the lighting apparatuses based on the illuminations of the different zones of lighting area set by user to accurately provide the light where it's needed.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automatic lighting control apparatus, comprising:
an optical lens, for projecting the images of lighting area of lighting apparatuses to an image sensor;
an image sensor, for capturing images of lighting area of lighting apparatuses;
an image processing unit being connected to the image sensor, for capturing and processing image signals from the image sensor;
a lighting control unit, which is connected to the image processing unit, for getting the illumination of images of lighting area of lighting apparatuses or its related parameters from the image processing unit, and outputting a lighting control signal to lighting apparatuses to adjust magnitude of light output of lighting apparatuses to maintain proper illumination levels of lighting area when the illumination of lighting area is changed.

2. The automatic lighting control apparatus according to claim 1, wherein the image sensor is a CCD image sensor.

3. The automatic lighting control apparatus according to claim 1, wherein the image sensor is a CMOS image sensor.

4. The automatic lighting control apparatus according to claim 1, wherein the image processing unit is an integrated circuit which operates arithmetic and logic processing or digital signal processing or both.

5. The automatic lighting control apparatus according to claim 1, wherein the lighting control unit is an integrated circuit which operates arithmetic and logic processing or digital signal processing or both.

6. The automatic lighting control apparatus according to claim 1, wherein the image processing unit and the image sensor is configured into a sole integrated circuit.

7. The automatic lighting control apparatus according to claim 1, wherein the lighting control unit, the image processing unit is configured into a sole integrated circuit.

8. The automatic lighting control apparatus according to claim 1, wherein the lighting control unit, the image processing unit and the image sensor is configured into a sole integrated circuit.

9. The automatic lighting control apparatus according to claim 1, wherein lighting apparatuses are apparatuses with electric light sources for lighting and can be controlled via turn on and off or adjust magnitude of their light output.

10. The automatic lighting control apparatus according to claim 1, wherein the lighting control signal outputted by the lighting control unit is a lighting control signal to adjust magnitude of light output of lighting apparatuses.

11. The automatic lighting control apparatus according to claim 10, wherein the lighting control signal is an electric pulse width modulation signal.

12. The automatic lighting control apparatus according to claim 10, wherein the lighting control signal is an electric analog signal.

13. The automatic lighting control apparatus according to claim 10, wherein the lighting control signal is an electric digital signal.
